(19) United States
(12) Patent Application Publication
(10) Pub. No.: US 2023/0342811 A1
(43) Pub. Date: Oct. 26, 2023

(54) Advertising Fraud Detection Apparatus And Method

(71) Applicant: Netmarble Corporation, Seoul (KR)

(72) Inventors: Daehwan BANG, Seoul (KR); Jonghun MOON, Seoul (KR); Junho SON, Seoul (KR)

(21) Appl. No.: 18/119,085

(22) Filed: Mar. 8, 2023

(30) Foreign Application Priority Data
Apr. 26, 2022 (KR) 10-2022-0051328

(51) Int. Cl. G06Q 30/0241

(52) U.S. Cl. CPC G06Q 30/0248

(57) ABSTRACT

An advertising fraud detection apparatus and method are disclosed. The advertising fraud detection apparatus includes a processor and a memory storing instructions executable by the processor, in which the processor receives user data of a user of content that is a target of an online advertisement, extracts advertising fraud-related features from the user data, obtains first output advertising fraud data from a neural network-based first advertising fraud detection model having the extracted features as inputs, obtains second output advertising fraud data from an autoencoder-based second advertising fraud detection model having the extracted features as inputs, obtains third output advertising fraud data from a logistic regression-based third advertising fraud detection model having the extracted features as inputs, and determines whether the user is a fraudulent advertising user based on the first output advertising fraud data, the second output advertising fraud data, and the third output advertising fraud data.

### CROSS-REFERENCE TO RELATED APPLICATIONS

This application claims priority under 35 U.S.C. §119 to Korean Patent Application No. 10-2022-0051328 filed on Apr. 26, 2022, in the Korean Intellectual Property Office. The entire contents of which are incorporated herein by reference in their entirety.

### FIELD

At least one example embodiment relates to a technology for detecting advertising fraud.

### BACKGROUND

An advertiser that provides content (e.g., applications) may advertise their content to general users via electronic media. A manager of the electronic media may be a publisher and, as new users are introduced to the content through an advertisement, may charge an advertising fee to the advertiser in return for this. Advertising fraud may refer to an act that deliberately and fraudulently generates traffic and charges an advertising fee therefor.

### SUMMARY

This section provides a general summary of the disclosure and is not a comprehensive disclosure of its full scope or all of its features.

At least one example embodiment relates to an advertising fraud detection apparatus.

In at least one example embodiment, the advertising fraud detection apparatus may include: a processor; and a memory configured to store instructions to be executed by the processor. When the instructions are executed by the processor, the processor may receive user data of a user associated with content that is a target of an online advertisement; extract advertising fraud-related features from the user data; obtain first output advertising fraud data from a neural network-based first advertising fraud detection model having the extracted features as an input; obtain second output advertising fraud data from an autoencoder-based second advertising fraud detection model having the extracted features as an input; obtain third output advertising fraud data from a logistic regression-based third advertising fraud detection model having the extracted features as an input; and determine whether the user is a fraudulent advertising user based on the first output advertising fraud data, the second output advertising fraud data, and the third output advertising fraud data.

In at least one example embodiment, the processor may determine final output advertising fraud data through an ensemble of the first output advertising fraud data, the second output advertising fraud data, and the third output advertising fraud data; and determine whether the user is the fraudulent advertising user based on the final output advertising fraud data.

In at least one example embodiment, the first output advertising fraud data may include probability values that the user data belongs to a first group introduced through a reliable self-attributing network (SAN) medium, a second group introduced through a reliable medium among media that are not the SAN medium, and a third group introduced through a medium having an advertising fraud history. The second output advertising fraud data may include a restoration error of data restored from the user data by an autoencoder. The third output advertising fraud data may include probability values that the user data belongs to the first group, the second group, and the third group.

In at least one example embodiment, the processor may determine, to be a first candidate group to which the user data is likely to belong, a group having a highest probability value of the first output advertising fraud data among the first group, the second group, and the third group; when a restoration error of the second output advertising fraud data is greater than or equal to a set value, determine the third group to be a second candidate group to which the user data is likely to belong; when the restoration error of the second output advertising fraud data is less than the set value, determine the first group and the second group to be the second candidate group; and determine, to be a third candidate group to which the user data is likely to belong, a group having a highest probability value of the third output advertising fraud data among the first group, the second group, and the third group.

In at least one example embodiment, the processor may determine the final output advertising fraud data through an ensemble of the first candidate group, the second candidate group, and the third candidate group under a set condition.

In at least one example embodiment, the processor may determine that the user data corresponds to the fraudulent advertising user when a final group included in the final output advertising fraud data is the third group; and determine that the user data does not correspond to the fraudulent advertising user when the final group included in the final output advertising fraud data is the first group or the second group.

In at least one example embodiment, the advertising fraud-related features may include a feature relating to an installation of the content that is the target of the online advertisement, a feature relating to an execution of the content, a feature relating to a login to the content, and a feature relating to a click on the online advertisement.

In at least one example embodiment, the processor may determine a ratio of users determined as the fraudulent advertising user to users introduced through media for each medium posting the online advertisement; and determine a fraudulent advertising medium based on the determined ratio.

In at least one example embodiment, the processor may output a report on the determined fraudulent advertising medium.

In at least one example embodiment, the processor may add user data of a user for which whether they are the fraudulent advertising user has been determined to training data used for training of the first advertising fraud detection model, the second advertising fraud detection model, and the third advertising fraud detection model.

In at least one example embodiment, the first advertising fraud detection model may be a model to which an explainable artificial intelligence (XAI) model configured to further output a feature on which the output of the first output advertising fraud data is based is applied.

At least one example embodiment relates to an advertising fraud detection method.

In at least one example embodiment, the advertising fraud detection method may include: receiving user data of users associated with online advertisements or content that is a target of the online advertisement; extracting advertising fraud-related features from the user data; obtaining first output advertising fraud data from a neural network-based first advertising fraud detection model having the extracted features as an input; obtaining second output advertising fraud data from an autoencoder-based second advertising fraud detection model having the extracted features as an input; obtaining third output advertising fraud data from a logistic regression-based third advertising fraud detection model having the extracted features as an input; and determining whether the user is a fraudulent advertising user based on the first output advertising fraud data, the second output advertising fraud data, and the third output advertising fraud data.

In at least one example embodiment, the determining whether the user is the fraudulent advertising user may include: determining final output advertising fraud data through an ensemble of the first output advertising fraud data, the second output advertising fraud data, and the third output advertising fraud data; and determining whether the user is the fraudulent advertising user based on the final output advertising fraud data.

In at least one example embodiment, the first output advertising fraud data may include probability values that the user data belongs to a first group introduced through a reliable SAN medium, a second group introduced through a reliable medium among media that are not the SAN medium, and a third group introduced through a medium having an advertising fraud history. The second output advertising fraud data may include a restoration error of data restored from the user data by an autoencoder. The third output advertising fraud data may include probability values that the user data belongs to the first group, the second group, and the third group.

In at least one example embodiment, the determining the final output advertising fraud data may include: determining, to be a first candidate group to which the user data is likely to belong, a group having the highest probability value of the first output advertising fraud data among the first group, the second group, and the third group; when a restoration error of the second output advertising fraud data is greater than or equal to a set value, determining the third group to be a second candidate group to which the user data is likely to belong; when the restoration error of the second output advertising fraud data is less than the set value, determining the first group and the second group to be the second candidate group; and determining, to be a third candidate group to which the user data is likely to belong, a group having the highest probability value of the third output advertising fraud data among the first group, the second group, and the third group.

In at least one example embodiment, the determining the final output advertising fraud data may further include: determining the final output advertising fraud data through an ensemble of the first candidate group, the second candidate group, and the third candidate group under a set condition.

In at least one example embodiment, the determining whether the user is the fraudulent advertising user may include: determining that the user data corresponds to the fraudulent advertising user when a final group included in the final output advertising fraud data is the third group; and determining that the user data does not correspond to the fraudulent advertising user when the final group included in the final output advertising fraud data is the first group or the second group.

In at least one example embodiment, the advertising fraud-related features may include a feature relating to an installation of the content that is the target of the online advertisement, a feature relating to an execution of the content, a feature relating to a login to the content, and a feature relating to a click on the online advertisement.

In at least one example embodiment, the advertising fraud detection method may further include: determining a ratio of users determined as the fraudulent advertising user to users introduced through media for each medium posting the online advertisement; and determining a fraudulent advertising medium based on the determined ratio.

In at least one example embodiment, the advertising fraud detection method may further include: outputting a report on the determined fraudulent advertising medium.

In at least one example embodiment, the advertising fraud detection method may further include: adding user data of a user for which whether they are the fraudulent advertising user has been determined to training data used for training of the first advertising fraud detection model, the second advertising fraud detection model, and the third advertising fraud detection model.

At least one example embodiment relates to a training device configured to train an advertising fraud detection apparatus.

In at least one example embodiment, the training device may include: a processor; and a memory configured to store instructions to be executed by the processor. When the instructions are executed by the processor, the processor may receive training data relating to users of content that is a target of an online advertisement; extract advertising fraud-related features from the training data; obtain first predicted advertising fraud data from a neural network-based first advertising fraud detection model having the extracted features as an input; obtain second predicted advertising fraud data from an autoencoder-based second advertising fraud detection model having the extracted features as an input; obtain third predicted advertising fraud data from a logistic regression-based third advertising fraud detection model having the extracted features as an input; and update parameters of at least one of the first advertising fraud detection model, the second advertising fraud detection model, or the third advertising fraud detection model, based on the first predicted advertising fraud data, the second predicted advertising fraud data, and the third predicted advertising fraud data.

In at least one example embodiment, the advertising fraud-related features may include a feature relating to an installation of the content that is the target of the online advertisement, a feature relating to an execution of the content, a feature relating to a login to the content, and a feature relating to a click on the online advertisement.

In at least one example embodiment, the processor may further perform oversampling on the training data.

In at least one example embodiment, the processor may further perform clustering on the training data.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 is a diagram illustrating an example of an advertising fraud detection model according to at least one example embodiment;

FIG. 2 is a flowchart illustrating an example of training performed by an advertising fraud detection model according to at least one example embodiment;

FIG. 3 is a flowchart illustrating an example of inference performed by an advertising fraud detection model according to at least one example embodiment;

FIGS. 4 through 8 are diagrams illustrating examples of advertising fraud-related features according to at least one example embodiment;

FIG. 9 is a diagram illustrating an example of a report output by an advertising fraud detection apparatus according to at least one example embodiment;

FIG. 10 is a block diagram illustrating an example of a training device according to at least one example embodiment; and

FIG. 11 is a block diagram illustrating an example of an advertising fraud detection apparatus according to at least one example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected,” “coupled,” or “joined” to another component, a third component may be “connected,” “coupled,” and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted in the figures may occur out of the order. For example, two figures shown in succession may in fact be executed substantially concurrently or may sometimes be executed in the reverse order, depending upon the functionality/acts involved.

Unless otherwise defined, all terms, including technical and scientific terms, used herein have the same meaning as commonly understood by one of ordinary skill in the art to which the disclosure of this application pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings, and like reference numerals in the drawings refer to like elements throughout.

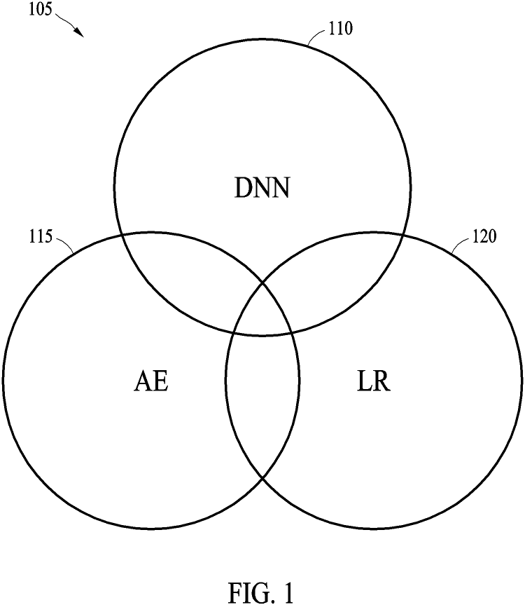

FIG. 1 is a diagram illustrating an example of an advertising fraud detection model according to at least one example embodiment.

An advertiser providing content (e.g., an application) may advertise the content to general users through an electronic medium (hereinafter simply referred to as “medium”). A manager of the medium may be a publisher. New users may be introduced to content through advertisements and, in return for this, publishers may charge advertisers advertising fees for the advertisements. For example, an online advertisement for content A may be displayed on a user terminal of a user. In this example, when the user selects or clicks this advertisement, the user may be moved to a page from which they are able to download the content A. When the content A is installed in a normal way in the user terminal, a publisher of a medium may charge an advertiser of the content A an advertising fee in return for the installation. Advertising fraud in online advertisements refers to an act of a publisher charging advertising fees by generating traffic unfairly and fraudulently.

For example, a publisher may steal traffic of users who have installed content through an advertisement posted by another publisher and manipulate it as if it has generated through their own medium (which is referred to as “attribution manipulation”), or steal traffic of organic users who have installed content without advertisements and manipulate it as if it has generated through their own medium (which is referred to as “organic poaching”).

Alternatively, a publisher may use fake users who are not interested in content to click online advertisements or install content through the online advertisements for the purpose of increasing their advertising achievements, not for the purpose of really using the content, (which is referred to as “fake install”). For example, a publisher may generate traffic to online advertisements by using a plurality of terminals that search for the online advertisements and install corresponding contents without actual use of the contents, such as, for example, install farms. Alternatively, a publisher may manipulate advertising achievement measurement records (which is referred to as “software development kit (SDK) spoofing”) to generate traffic of fake users who do not exist in reality but only on the records.

A publisher may charge advertisers advertising fees based on manipulated data. The advertisers may verify whether the data provided by the publisher is manipulated or not and may thereby detect whether there is advertising fraud.

Referring to FIG. 1, illustrated is an advertising fraud detection model 105 according to at least one example embodiment.

In at least one example embodiment, an advertising fraud detection apparatus (e.g., an advertising fraud detection apparatus 1100 of FIG. 11) may receive user data of a user associated with content that is a target of an online advertisement, extract advertising fraud-related features from the user data, input the extracted features to the advertising fraud detection model 105, and determine whether the user is a fraudulent advertising user.

In at least one example embodiment, the advertising fraud detection model 105 may include a neural network (e.g., a deep neural network (DNN))-based first advertising fraud detection model 110 having the extracted features as an input, an autoencoder (AE)-based second advertising fraud detection model 115 having the extracted features as an input, and a logistic regression (LR)-based third advertising fraud detection model 120 having the extracted features as an input.

The advertising fraud detection apparatus may obtain first output advertising fraud data from the first advertising fraud detection model 110, obtain second output advertising fraud data from the second advertising fraud detection model 115, and obtain third output advertising fraud data from the third advertising fraud detection model 120.

In at least one example embodiment, the advertising fraud detection apparatus may determine final output advertising fraud data through an ensemble of the first output advertising fraud data, the second output advertising fraud data, and the third output advertising fraud data.

The advertising fraud detection apparatus may determine whether the user is the fraudulent advertising user based on the final output advertising fraud data.

In at least one example embodiment, the advertising fraud detection apparatus may determine a ratio of users determined as the fraudulent advertising user to users introduced through media for each medium posting where the online advertisement is posted. The advertising fraud detection apparatus may determine a fraudulent advertising medium based on the determined ratio.

The advertising fraud detection apparatus may output a report on the determined fraudulent advertising medium.

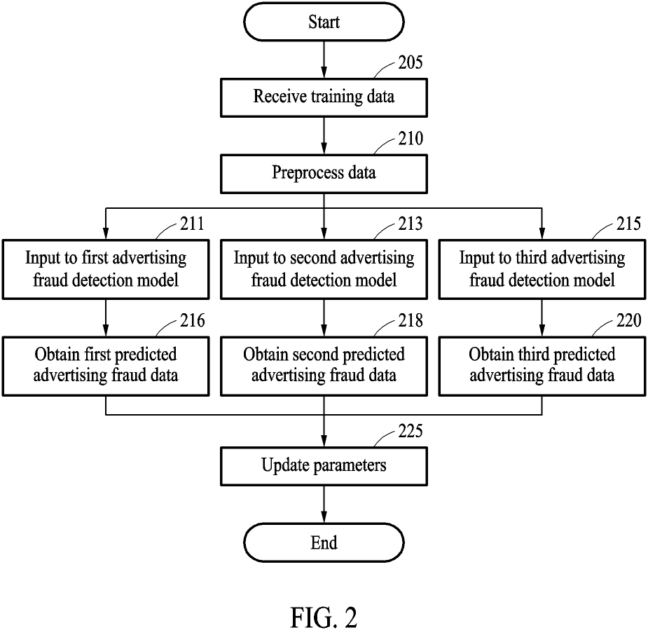

FIG. 2 is a flowchart illustrating an example of training performed by an advertising fraud detection model according to at least one example embodiment.

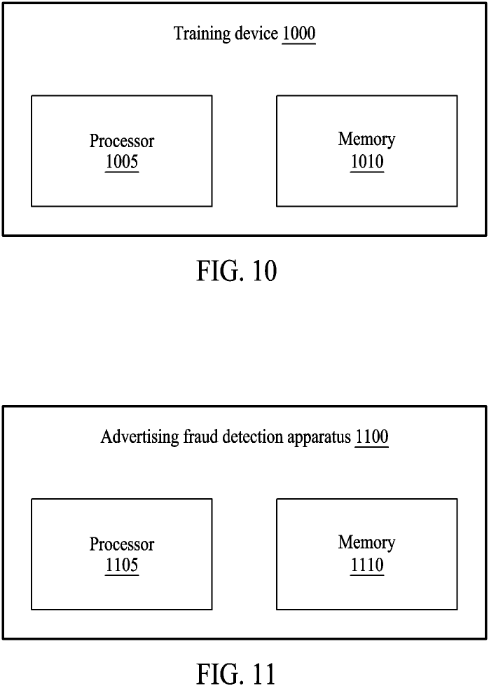

In operation 205, a training device (e.g., a training device 1000 of FIG. 10) configured to train an advertising fraud detection apparatus may receive training data relating to users of content that is a target of an online advertisement. The training data may include user data of users introduced to the content through or not through the online advertisement.

In operation 210, the training device may preprocess the training data to train an advertising fraud detection model of the advertising fraud detection apparatus. For example, the training device may classify the training data into a first group introduced through a reliable self-attribute network (SAN) medium, a second group introduced through a reliable medium among media that are not the SAN medium, a third group introduced through a medium having an advertising fraud history, and a fourth group other than those.

In at least one example embodiment, this operation of classifying the training data into the first to fourth groups may be omitted. For example, the training data may be received by the training device as being classified into the first to fourth groups.

In general, the number of general users is greater than the number of fraudulent advertising users, and thus the amounts of data respectively belonging to the first to fourth groups of the training data may not be equal. In at least one example embodiment, in operation 210, the training device may perform clustering on training data belonging to the fourth group, and classify again the training data belonging to the fourth group into any one of the first group, the second group, and the third group based on a result of the clustering. In at least one example embodiment, in operation 210, the training device may perform oversampling, such as, for example, a synthetic minority oversampling technique (SMOTE), to adjust the respective amounts of data of the first group, the second group, and the third group to be equal.

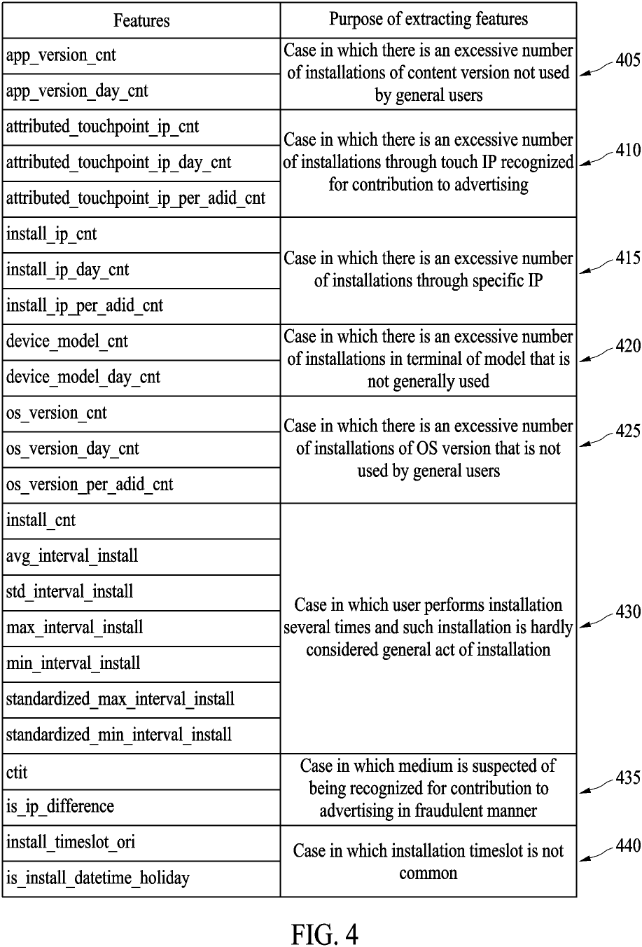

In operation 210, the training device may extract preset advertising fraud-related features from the training data. The advertising fraud-related features will be described below with reference to FIGS. 4 to 8.

The training device may input the extracted features to a first advertising fraud detection model in operation 211, input the extracted features to a second advertising fraud detection model in operation 213, and input the extracted features to a third advertising fraud detection model in operation 215. The training device may obtain first predicted advertising fraud data from the first advertising fraud detection model in operation 216, obtain second predicted advertising fraud data from the second advertising fraud detection model in operation 218, and obtain third predicted advertising fraud data from the third advertising fraud detection model in operation 220. The first predicted advertising fraud data may include probability values that the training data belongs to the first group, the second group, and the third group. The second predicted advertising fraud data may include a restoration error of data restored by an autoencoder of the second advertising fraud detection model. The third predicted advertising fraud data may include probability values that the training data belongs to the first group, the second group, and the third group.

In operation 225, the training device may update parameters of at least one of the first advertising fraud detection model, the second advertising fraud detection model, or the third advertising fraud detection model, based on the first predicted advertising fraud data, the second predicted advertising fraud data, and the third predicted advertising fraud data.

In at least one example embodiment, the first advertising fraud detection model may be configured to learn an advertising fraud pattern from the features. The first advertising fraud detection model trained in such a way may be used to accurately classify data belonging to the second group. In at least one example embodiment, a neural network of the first advertising fraud detection model may be a DNN. In at least one example embodiment, an explainable artificial intelligence (XAI) model such as Shapley additive explanation (SHAP) or local interpretable model-agnostic explanations (LIME) may be applied to understand an output of the first advertising fraud detection model. As the XAI model is applied to the first advertising fraud detection model, the first advertising fraud detection model may output features (e.g., features of FIGS. 4 to 8) that are a basis from which the first predicted advertising fraud data is inferred, along with the first predicted advertising fraud data.

In at least one example embodiment, the second advertising fraud detection model based on the autoencoder may be trained to minimize a difference between an input and an output based on data of the first group and data of the second group of the training data. Because features extracted for the fraudulent advertising user are distinguished from those of a normal general user, the second advertising fraud detection model trained in such a way may be used to accurately classify data belonging to the third group. In at least one example embodiment, an XAI model that represents a feature having the greatest difference between an input and an output of the second advertising fraud detection model may be applied to the second advertising fraud detection model to understand the output of the second advertising fraud detection model.

In at least one example embodiment, the third advertising fraud detection model based on logistic regression may be trained to classify input data into any one of the first group, the second group, and the third group. The third advertising fraud detection model, which is an interpretable model, may output features (e.g., features having a high contribution among the features of FIGS. 4 to 8) that are a basis from which the input data is classified into any one of the first group, the second group, and the third group, and respective contributions of the features. As the third advertising fraud detection model is used along with the first advertising fraud detection model, an understanding of the output of the first advertising fraud detection model may be improved. In addition, as the third advertising fraud detection model is used along with the second advertising fraud detection model, the accuracy of the output of the second advertising fraud detection model may be increased.

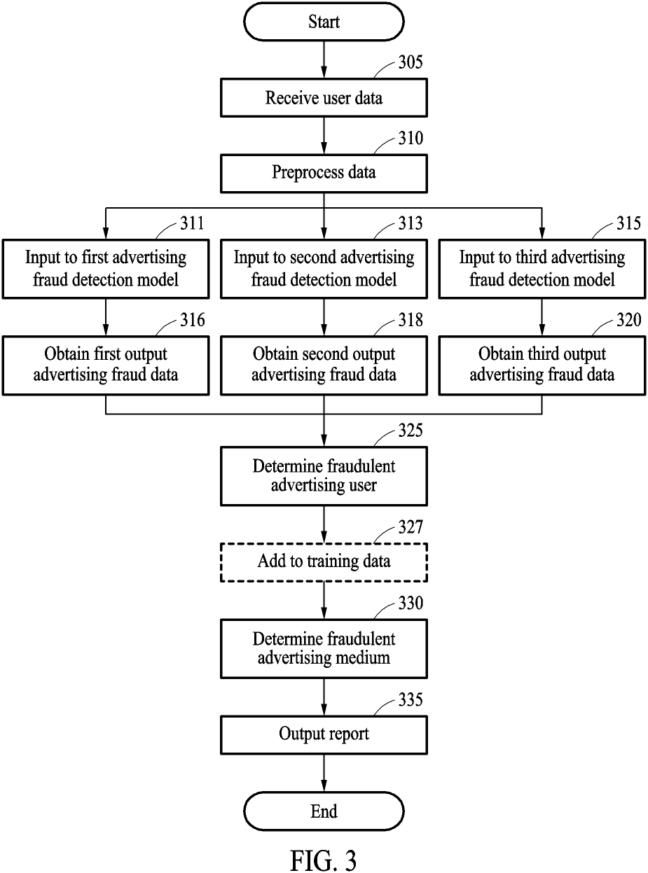

Hereinafter, an operation of detecting a fraudulent advertising user using a trained advertising fraud detection model will be described with reference to FIG. 3.

FIG. 3 is a flowchart illustrating an example of inference performed by an advertising fraud detection model according to at least one example embodiment.

In operation 305, an advertising fraud detection apparatus (e.g., the advertising fraud detection apparatus 1100 of FIG. 11) according to at least one example embodiment may receive user data of a user associated with content that is a target of an online advertisement. The user data may include user data of users introduced to the content through or not through the online advertisement.

In operation 310, the advertising fraud detection apparatus may extract advertising fraud-related features from the user data. The features extracted in operation 310 may be the same as the features extracted in operation 210 described above.

The advertising fraud detection apparatus may input the extracted features to a first advertising fraud detection model in operation 311, input the extracted features to a second advertising fraud detection model in operation 313, and input the extracted features to a third advertising fraud detection model in operation 315. The advertising fraud detection apparatus may obtain first output advertising fraud data from the first advertising fraud detection model in operation 316, obtain second output advertising fraud data from the second advertising fraud detection model in operation 318, and obtain third output advertising fraud data from the third advertising fraud detection model in operation 320.

The first output advertising fraud data may include probability values that the user data belongs to a first group, a second group, and a third group. The second output advertising fraud data may include a restoration error of data restored from the user data by an autoencoder of the second advertising fraud detection model. The third output advertising fraud data may include probability values that the user data belongs to the first group, the second group, and the third group.

In at least one example embodiment, the first advertising fraud detection model may be a model to which an XAI model such as SHAP or LIME is applied. As the XAI model is applied to the first advertising fraud detection model, the first advertising fraud detection model may output features (e.g., the features of FIGS. 4 to 8) that are a basis from which the first output advertising fraud data is output, along with the first output advertising fraud data.

In at least one example embodiment, the second advertising fraud detection model may be an XAI model that represents a feature having the greatest difference between an input and an output of the second advertising fraud detection model.

In at least one example embodiment, the third advertising fraud detection model, which is an interpretable model, may output features (e.g., features having a high contribution among the features of FIGS. 4 to 8) that are a basis from which input data is classified into any one of the first group, the second group, and the third group, and respective contributions of the features.

In operation 325, the advertising fraud detection apparatus may determine whether the user is a fraudulent advertising user based on the first output advertising fraud data, the second output advertising fraud data, and the third output advertising fraud data.

In at least one example embodiment, the advertising fraud detection apparatus may determine final output advertising fraud data through an ensemble of the first output advertising fraud data, the second output advertising fraud data, and the third output advertising fraud data.

In at least one example embodiment, the advertising fraud detection apparatus may determine the final output advertising fraud data based on probability values included in the first output advertising fraud data, a restoration error included in the second output advertising fraud data, and probability values included in the third output advertising fraud data.

For example, the advertising fraud detection apparatus may determine, to be a first candidate group to which the user data is likely to belong, a group having the highest probability value of the first output advertising fraud data among the first group, the second group, and the third group. When the restoration error of the second output advertising fraud data is greater than or equal to a set value, the advertising fraud detection apparatus may determine the third group to be a second candidate group to which the user data is likely to belong. When the restoration error of the second output advertising fraud data is less than the set value, the advertising fraud detection apparatus may determine the first group and the second group to be the second candidate group. The advertising fraud detection apparatus may determine, to be a third candidate group to which the user data is likely to belong, a group having the highest probability value of the third output advertising fraud data among the first group, the second group, and the third group. The advertising fraud detection apparatus may determine the final output advertising fraud data through an ensemble of the first candidate group, the second candidate group, and the third candidate group according to a set condition. The final output advertising fraud data may include a final group to which the user data is determined to belong among the first group, the second group, and the third group.

The advertising fraud detection apparatus may determine whether the user is a fraudulent advertising user based on the final output advertising fraud data. For example, the advertising fraud detection apparatus may determine that the user is not the fraudulent advertising user when the final group included in the final output advertising fraud data is the first group or the second group, and determine that the user is the fraudulent advertising user when the final group is the third group.

In operation 327, the advertising fraud detection apparatus may add the user data for which whether the user is the fraudulent advertising user is determined in operation 325 to training data (e.g., the training data in operation 205 of FIG. 2) used to train the advertising fraud detection apparatus. For example, when the user is determined to be the fraudulent advertising user, the advertising fraud detection apparatus may add user data of the user determined as the fraudulent advertising user to training data of the third group. When the user is determined not to be the fraudulent advertising user, the advertising fraud detection apparatus may add the user data to training data of the first group or the second group.

The advertising fraud detection apparatus may be trained again based on the added training data, and as it is trained again, its advertising fraud detection performance may be improved accordingly. In at least one example embodiment, operation 327 may be omitted.

In operation 330, the advertising fraud detection apparatus may determine a ratio of users determined as the fraudulent advertising user to users introduced through media for each medium posting the online advertisement, and may determine a fraudulent advertising medium based on at least one of the determined ratio or the number of installations of the content through the corresponding medium. For example, when the determined ratio exceeds a set ratio and the number of the installations of the content through the medium exceeds a set number, the advertising fraud detection apparatus may determine the corresponding medium to be the fraudulent advertising medium.

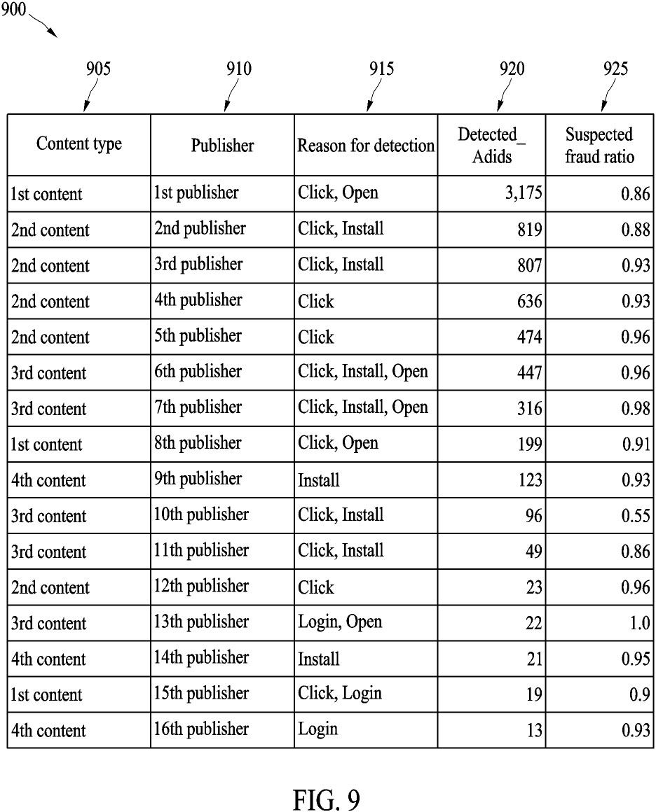

In operation 335, the advertising fraud detection apparatus may output a report on the fraudulent advertising medium determined in operation 330. The report will be described below with reference to FIG. 9.

In at least one example embodiment, the advertising fraud detection model may include a rule-based fourth advertising fraud detection model. The advertising fraud detection apparatus may input the features extracted in operation 310 to the fourth advertising fraud detection model to obtain fourth output advertising fraud data. In operation 335, the advertising fraud detection apparatus may output a report based on the final output advertising fraud data determined in operation 325 and the fourth output advertising fraud data.

FIGS. 4 through 8 are diagrams illustrating examples of advertising fraud-related features according to at least one example embodiment.

FIG. 4 illustrates features relating to an installation of content.

In at least one example embodiment, advertising fraud-related features may include a feature relating to an installed content version and a feature relating to the date on which the version is installed to detect a case 405 in which there is an excessive number of installations of a content version that is not used by general users.

In at least one example embodiment, the advertising fraud-related features may include a feature relating to a touchpoint Internet protocol (IP) recognized for a contribution to advertising, a feature relating to the data on which content is installed through the touchpoint IP, and a feature relating to users installing the content through the touchpoint IP, to detect a case 410 in which there is an excessive number of installations through the touchpoint IP recognized for the contribution to advertising. The feature relating to the users installing the content may include advertising identification information (e.g., advertising identifiers (ADIDs)) of the users.

In at least one example embodiment, the advertising fraud-related features may include a feature relating to an IP through which content is installed, a feature relating to the date on which the content is installed through the IP, and a feature relating to users installing the content through the IP, to detect a case 415 in which there is an excessive number of installations through a specific IP.

In at least one example embodiment, the advertising fraud-related features may include a feature relating to a model of a terminal installing content and a feature relating to the date on which the content is installed on the model of the terminal installing the content, to detect a case 420 in which there is an excessive number of installations in a terminal of a model that is not generally used.

In at least one example embodiment, the advertising fraud-related features may include a feature relating to an operating system (OS) of a terminal installing content, a feature relating to the date on which the content is installed under the OS of the terminal installing the content, and a feature relating to users installing the content under the OS of the terminal installing the content, to detect a case 425 in which there is an excessive number of installations of a terminal OS version that is not used by general users.

In at least one example embodiment, the advertising fraud-related features may include a feature relating to the number of installations of content and a feature relating to installation intervals, to detect a case 430 in which a user performs installation several times and such an installation is hardly considered a general act of installation.

In at least one example embodiment, the advertising fraud-related features may include a feature relating to a time difference between click and installation of an online advertisement and a feature relating to whether an IP at the time of the click and an IP at the time of the installation are different from each other, to detect a case 435 in which a medium is suspected of being recognized for a contribution to advertising in a fraudulent manner.

In at least one example embodiment, the advertising fraud-related features may include a feature relating to an installation timeslot of content, to detect a case 440 in which an installation timeslot of content is not common.

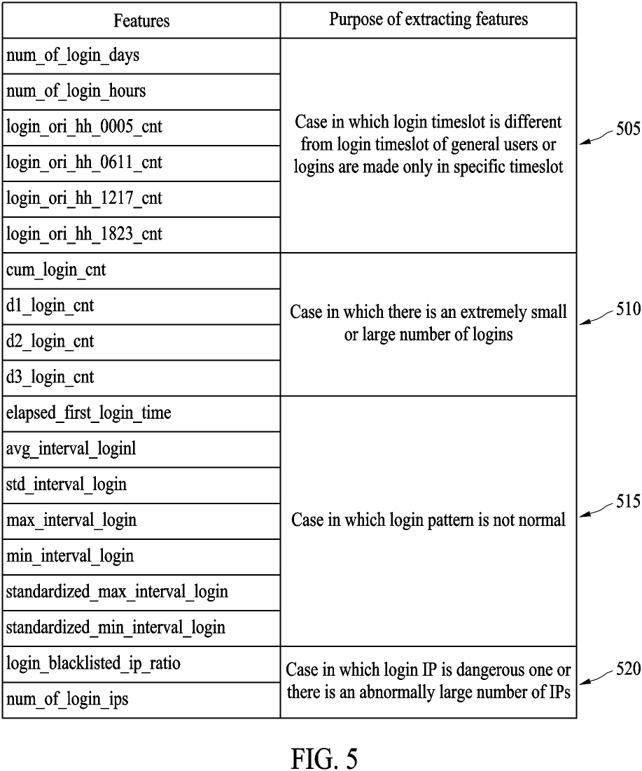

FIG. 5 illustrates features relating to a login to content.

In at least one example embodiment, the advertising fraud-related features may include a feature relating to a login timeslot, to detect a case 505 in which a login timeslot is different from a login timeslot of general users or logins are made only in a specific timeslot.

In at least one example embodiment, the advertising fraud-related features may include a feature relating to the number of logins to content, to detect a case 510 in which there is an extremely small or large number of logins.

In at least one example embodiment, the advertising fraud-related features may include a feature relating to a time used from an installation of content to an initial login and a feature relating to a time interval between logins, to detect a case 515 in which a login pattern is not normal.

In at least one example embodiment, the advertising fraud-related features may include a feature relating to a ratio of logins with backlist IPs and a feature relating to the number of login IPs, to detect a case 520 in which a login IP is a dangerous IP or there is an abnormally large number of IPs attempting at logins.

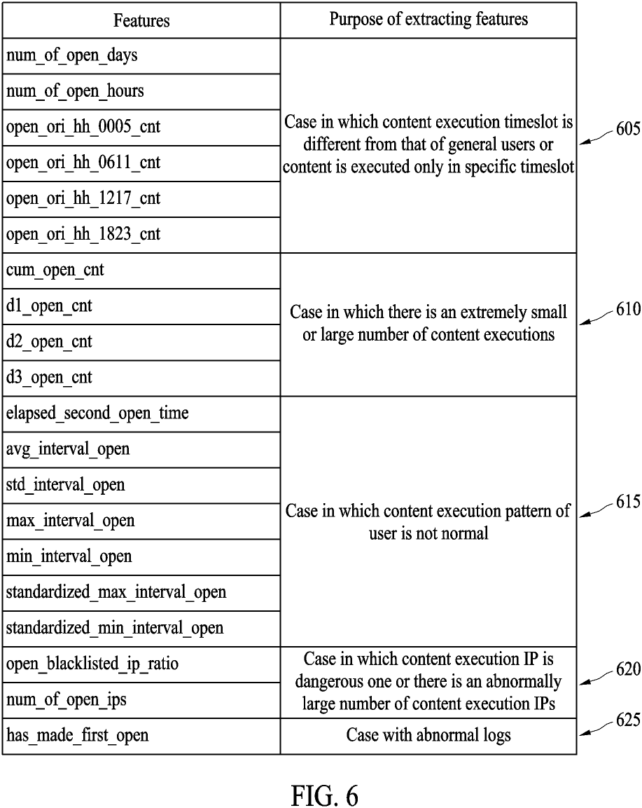

FIG. 6 illustrates features relating to the opening (or execution) of content.

In at least one example embodiment, the advertising fraud-related features may include a feature relating to an execution date of content, a feature relating to an execution time of the content, and a feature relating to whether the content is executed in a specific timeslot, to detect a case 605 in which a content execution timeslot is different from that of general users or the content is executed only in a specific timeslot.

In at least one example embodiment, the advertising fraud-related features may include a feature relating to the number of executions of content, to detect a case 610 in which there is an extremely small or large number of executions of content.

In at least one example embodiment, the advertising fraud-related features may include a feature relating to a time used until content is executed second time and a feature relating to a time interval of executions of the content, to detect a case 615 in which a content execution pattern of users is not normal.

In at least one example embodiment, the advertising fraud-related features may include a feature relating to a ratio of executions on blacklisted IPs and a feature relating to the number of IPs executing content, to detect a case 620 in which an IP executing content is a dangerous IP or there is an abnormally large number of IPs executing the content.

In at least one example embodiment, the advertising fraud-related features may include a feature relating to an execution log, to detect a case 625 with abnormal logs.

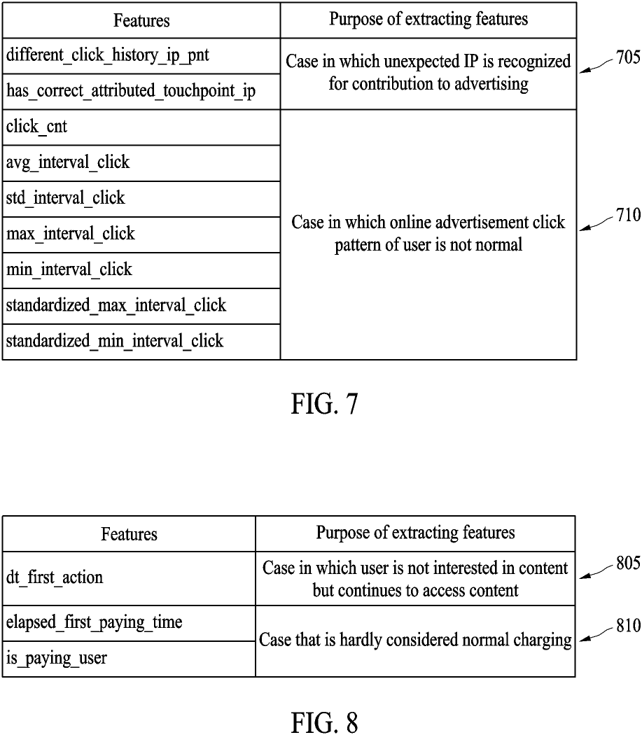

FIG. 7 illustrates features relating to clicks on online advertisements.

In at least one example embodiment, the advertising fraud-related features may include a feature relating to an IP clicking an online advertisement and a feature relating to a touchpoint IP recognized for a contribution to advertising, to detect a case 705 in which an unexpected IP is recognized for a contribution to advertising.

In at least one example embodiment, the advertising fraud-related features may include a feature relating to the number of clicks on an online advertisement and a feature relating to a time interval of clicks on the online advertisement, to detect a case 710 in which an online advertisement click pattern of users is not normal.

FIG. 8 illustrates features relating to events and sales.

In at least one example embodiment, the advertising fraud-related features may include a feature relating to an action of a user in response to content, to detect a case 805 in which a user is not interested in content but continues to access the content.

In at least one example embodiment, the advertising fraud-related features may include a feature relating to a time used until a first charging is made and a feature relating to whether a user charges a fee, to detect a case 810 hardly considered normal charging.

However, the features described above with reference to FIGS. 4 to 8 are provided merely as examples, and the advertising fraud-related features may include various features as needed.

FIG. 9 is a diagram illustrating an example of a report output by an advertising fraud detection apparatus according to at least one example embodiment.

An advertising fraud detection apparatus may output a report 900 on a fraudulent advertising medium as described above regarding operation 335 of FIG. 3, for example.

In at least one example embodiment, the report 900 may include a content type 905, a publisher (or medium) type 910, the most aggregated reason 915 for detection of advertising fraud by medium, the number 920 of users determined to be fraudulent advertising users by medium, and a ratio 925 of suspected fraudulent advertising users to total users.

In at least one example embodiment, the advertising fraud detection apparatus may further output a detailed report (not shown). The detailed report may include the number of sub-media belonging to the fraudulent advertising medium, a most accessed IP and country code of the fraudulent advertising medium, identification information of a fraudulent advertising user, features attributing to the determination of a user as a fraudulent advertising user, and information about a model that determines a user as a fraudulent advertising user. The detailed report may further include a distribution of features attributing to the detection of a most frequently detected fraudulent advertising medium, quartile values of the features, and identification information of a fraudulent advertising user of the corresponding fraudulent advertising medium.

In at least one example embodiment, the advertising fraud detection apparatus may output such a report on a periodic basis.

FIG. 10 is a block diagram illustrating an example of a training device according to at least one example embodiment.

Referring to FIG. 10, a training device 1000 according to at least one example embodiment may include a processor 1005 and a memory 1010 configured to store therein instructions to be executed by the processor 1005.

In at least one example embodiment, the processor 1005 may receive training data relating to users of content that is a target of an online advertisement. The training data may include user data of users who are introduced to the content through or not through the online advertisement. The processor 1005 may extract advertising fraud-related features (e.g., the advertising fraud-related features of FIGS. 4 to 8) from the training data.

In at least one example embodiment, operations 205, 210, 211, 213, 215, 216, 218, 220, and 225 of FIG. 2 may be performed by processor 1005. For example, the processor 1005 may obtain first predicted advertising fraud data from a neural network-based first advertising fraud detection model having the extracted features as an input, obtain second predicted advertising fraud data from an autoencoder-based second advertising fraud detection model having the extracted features as an input, and obtain third predicted advertising fraud data from a logistic regression-based third advertising fraud detection model having the extracted features as an input.

The processor 1005 may update parameters of at least one of the first advertising fraud detection model, the second advertising fraud detection model, or the third advertising fraud detection model based on the first predicted advertising fraud data, the second predicted advertising fraud data, and the third predicted advertising fraud data.

In at least one example embodiment, the training data may be received from the training device 1000 by being classified into a first group introduced through a reliable SAN medium, a second group introduced through a reliable medium among media that are not the SAN medium, a third group introduced through a medium with an advertising fraud history, and a fourth group other than those groups. Since the number of general users is generally greater than the number of fraudulent advertising users, the amounts of data belonging to the first to fourth groups of the training data may not be equal.

The processor 1005 may perform clustering on training data belonging to the fourth group, and may classify again the training data belonging to the fourth group to any one of the first group, the second group, and the third group based on a result of the clustering. In operation 210, the training device 1000 may perform oversampling, such as, for example, a SMOTE, on the training data to adjust the amounts of data of the first, second, and third groups to be equal.

FIG. 11 is a block diagram illustrating an example of an advertising fraud detection apparatus according to at least one example embodiment.

An advertising fraud detection apparatus 1100 according to at least one example embodiment may include a processor 1105 and a memory 1110 configured to store therein instructions to be executed by the processor 1105.

In at least one example embodiment, the processor 1105 may receive user data of a user associated with content that is a target of an online advertisement. The user data may include user data of users who are introduced to the content through or not through the online advertisement. The processor 1105 may extract advertising fraud-related features (e.g., the advertising fraud-related features of FIGS. 4 to 8) from the user data.

In at least one example embodiment, operations 305, 310, 311, 313, 315, 316, 318, 320, 325, 327, 330, and 335 of FIG. 3 may be performed by the processor 1105. For example, the processor 1105 may obtain first output advertising fraud data from a neural network-based first advertising fraud detection model having the extracted features as an input, obtain second output advertising fraud data from an autoencoder-based second advertising fraud detection model having the extracted features as an input, and obtain third output advertising fraud data from a logistic regression-based third advertising fraud detection model having the extracted features as an input.

The processor 1105 may determine whether the user is a fraudulent advertising user based on the first output advertising fraud data, the second output advertising fraud data, and the third output advertising fraud data.

The processor 1105 may determine final output advertising fraud data through an ensemble of the first output advertising fraud data, the second output advertising fraud data, and the third output advertising fraud data. For example, the processor 1105 may determine the final output advertising fraud data based on a probability included in the first output advertising fraud data, a restoration error included in the second output advertising fraud data, and a probability included in the third output advertising fraud data.

The processor 1105 may determine whether the user is the fraudulent advertising user based on the final output advertising fraud data.

The processor 1105 may add, to training data (e.g., the training data in operation 205 of FIG. 2) used to train the advertising fraud detection apparatus 1100, user data for which whether the user is the fraudulent advertising user or not is determined. For example, when a user is determined to be the fraudulent advertising user, the processor 1105 may add user data of the user determined as the fraudulent advertising user to training data of the third group. When a user is determined not to be the fraudulent advertising user, the processor 1105 may add user data of the user to training data of the first group or the second group.

The processor 1105 may determine a ratio of users determined as the fraudulent advertising user to users introduced through media for each medium posting the online advertisement, and may determine a fraudulent advertising medium based on at least one of the determined ratio or the number of installations of the content through the corresponding medium. For example, when the determined ratio exceeds a set ratio and the number of installations of content through a medium exceeds a set number of times, the advertising fraud detection apparatus 1100 may determine the medium to be the fraudulent advertising medium.

The processor 1105 may output a report (e.g., the report 900 of FIG. 9) on the determined fraudulent advertising medium.

The example embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An advertising fraud detection apparatus, comprising:
a processor; and
a memory configured to store instructions to be executed by the processor,
wherein, when the instructions are executed by the processor, the processor is configured to:
receive user data of a user associated with content that is a target of an online advertisement;
extract advertising fraud-related features from the user data;
obtain first output advertising fraud data from a neural network-based first advertising fraud detection model having the extracted features as an input;
obtain second output advertising fraud data from an autoencoder-based second advertising fraud detection model having the extracted features as an input;
obtain third output advertising fraud data from a logistic regression-based third advertising fraud detection model having the extracted features as an input; and
determine whether the user is a fraudulent advertising user based on the first output advertising fraud data, the second output advertising fraud data, and the third output advertising fraud data.

2. The advertising fraud detection apparatus of claim 1, wherein the processor is configured to:
determine final output advertising fraud data through an ensemble of the first output advertising fraud data, the second output advertising fraud data, and the third output advertising fraud data; and
determine whether the user is the fraudulent advertising user based on the final output advertising fraud data.

3. The advertising fraud detection apparatus of claim 2, wherein the first output advertising fraud data comprises probability values that the user data belongs to a first group introduced through a reliable self-attributing network (SAN) medium, a second group introduced through a reliable medium among media that are not the SAN medium, and a third group introduced through a medium having an advertising fraud history,
the second output advertising fraud data comprises a restoration error of data restored from the user data by an autoencoder, and
the third output advertising fraud data comprises probability values that the user data belongs to the first group, the second group, and the third group.

4. The advertising fraud detection apparatus of claim 3, wherein the processor is configured to:
determine, to be a first candidate group to which the user data is likely to belong, a group having a highest probability value of the first output advertising fraud data among the first group, the second group, and the third group;
when a restoration error of the second output advertising fraud data is greater than or equal to a set value, determine the third group to be a second candidate group to which the user data is likely to belong;
when the restoration error of the second output advertising fraud data is less than the set value, determine the first group and the second group to be the second candidate group; and
determine, to be a third candidate group to which the user data is likely to belong, a group having a highest probability value of the third output advertising fraud data among the first group, the second group, and the third group.

5. The advertising fraud detection apparatus of claim 4, wherein the processor is configured to:
determine the final output advertising fraud data through an ensemble of the first candidate group, the second candidate group, and the third candidate group under a set condition.

6. The advertising fraud detection apparatus of claim 5, wherein the processor is configured to:
when a final group comprised in the final output advertising fraud data is the third group, determine that the user data corresponds to the fraudulent advertising user; and
when the final group comprised in the final output advertising fraud data is the first group or the second group, determine that the user data does not correspond to the fraudulent advertising user.

7. The advertising fraud detection apparatus of claim 1, wherein the advertising fraud-related features comprise:
a feature relating to an installation of the content that is the target of the online advertisement, a feature relating to an execution of the content, a feature relating to a login to the content, and a feature relating to a click on the online advertisement.

8. The advertising fraud detection apparatus of claim 7, wherein the processor is configured to:
determine a ratio of users determined as the fraudulent advertising user to users introduced through media for each medium posting the online advertisement; and
determine a fraudulent advertising medium based on the determined ratio.

9. The advertising fraud detection apparatus of claim 1, wherein the processor is configured to:
add user data of a user for which whether they are the fraudulent advertising user has been determined to training data used for training of the first advertising fraud detection model, the second advertising fraud detection model, and the third advertising fraud detection model.

10. An advertising fraud detection method, comprising:
receiving user data of users associated with online advertisements or content that is a target of the online advertisement;
extracting advertising fraud-related features from the user data;
obtaining first output advertising fraud data from a neural network-based first advertising fraud detection model having the extracted features as an input;
obtaining second output advertising fraud data from an autoencoder-based second advertising fraud detection model having the extracted features as an input;
obtaining third output advertising fraud data from a logistic regression-based third advertising fraud detection model having the extracted features as an input; and
determining whether the user is a fraudulent advertising user based on the first output advertising fraud data, the second output advertising fraud data, and the third output advertising fraud data.

11. The advertising fraud detection method of claim 10, wherein the determining whether the user is the fraudulent advertising user comprises:
determining final output advertising fraud data through an ensemble of the first output advertising fraud data, the second output advertising fraud data, and the third output advertising fraud data; and
determining whether the user is the fraudulent advertising user based on the final output advertising fraud data.

12. The advertising fraud detection method of claim 11, wherein the first output advertising fraud data comprises probability values that the user data belongs to a first group introduced through a reliable self-attributing network (SAN) medium, a second group introduced through a reliable medium among media that are not the SAN medium, and a third group introduced through a medium having an advertising fraud history,
the second output advertising fraud data comprises a restoration error of data restored from the user data by an autoencoder, and
the third output advertising fraud data comprises probability values that the user data belongs to the first group, the second group, and the third group.

13. The advertising fraud detection method of claim 12, wherein the determining the final output advertising fraud data comprises:
determining, to be a first candidate group to which the user data is likely to belong, a group having a highest probability value of the first output advertising fraud data among the first group, the second group, and the third group;
when a restoration error of the second output advertising fraud data is greater than or equal to a set value, determining the third group to be a second candidate group to which the user data is likely to belong;
when the restoration error of the second output advertising fraud data is less than the set value, determining the first group and the second group to be the second candidate group; and
determining, to be a third candidate group to which the user data is likely to belong, a group having a highest probability value of the third output advertising fraud data among the first group, the second group, and the third group.

14. The advertising fraud detection method of claim 13, wherein the determining the final output advertising fraud data further comprises:
determining the final output advertising fraud data through an ensemble of the first candidate group, the second candidate group, and the third candidate group under a set condition.

15. The advertising fraud detection method of claim 14, wherein the determining whether the user is the fraudulent advertising user comprises:
when a final group comprised in the final output advertising fraud data is the third group, determining that the user data corresponds to the fraudulent advertising user; and
when the final group comprised in the final output advertising fraud data is the first group or the second group, determining that the user data does not correspond to the fraudulent advertising user.

16. The advertising fraud detection method of claim 10, wherein the advertising fraud-related features comprise:
a feature relating to an installation of the content that is the target of the online advertisement, a feature relating to an execution of the content, a feature relating to a login to the content, and a feature relating to a click on the online advertisement.

17. The advertising fraud detection method of claim 16, further comprising:
determining a ratio of users determined as the fraudulent advertising user to users introduced through media for each medium posting the online advertisement; and
determining a fraudulent advertising medium based on the determined ratio.

18. The advertising fraud detection method of claim 10, further comprising:
adding user data of a user for which whether they are the fraudulent advertising user has been determined to training data used for training of the first advertising fraud detection model, the second advertising fraud detection model, and the third advertising fraud detection model.

19. A non-transitory computer-readable storage medium storing instructions that, when executed by a processor, cause the processor to perform the advertising fraud detection method of claim 10.

20. A training device configured to train an advertising fraud detection apparatus, comprising:
a processor; and
a memory configured to store instructions to be executed by the processor,
wherein, when the instructions are executed by the processor, the processor is configured to:
receive training data relating to users of content that is a target of an online advertisement;
extract advertising fraud-related features from the training data;
obtain first predicted advertising fraud data from a neural network-based first advertising fraud detection model having the extracted features as an input;
obtain second predicted advertising fraud data from an autoencoder-based second advertising fraud detection model having the extracted features as an input;
obtain third predicted advertising fraud data from a logistic regression-based third advertising fraud detection model having the extracted features as an input; and
update parameters of at least one of the first advertising fraud detection model, the second advertising fraud detection model, or the third advertising fraud detection model, based on the first predicted advertising fraud data, the second predicted advertising fraud data, and the third predicted advertising fraud data.
